(19) United States
(12) Patent Application Publication
(10) Pub. No.: US 2021/0037871 A1
(43) Pub. Date: Feb. 11, 2021

(54) COMPOSITIONS FOR SWEETENING PROTEIN-BASED NUTRITION PRODUCTS

(71) Applicant: MEDINUTRA LLC, Dublin, OH (US)

(72) Inventor: Robert DiSilvestro, Dublin, OH (US)

(21) Appl. No.: 16/989,143

(22) Filed: Aug. 10, 2020

Related U.S. Application Data
(60) Provisional application No. 62/884,212, filed on Aug. 8, 2019.

(51) Int. Cl. A23L 33/16; A23L 33/125; A23L 27/30; A23L 33/17; A23L 33/21; A23L 2/395; A23L 2/66; A23L 2/60

(52) U.S. Cl. CPC A23L 33/16; A23L 33/125; A23L 27/37; A23L 33/17; A23V 2002/00; A23L 33/21; A23L 2/395; A23L 2/66; A23L 2/60; A23L 27/36

(57) ABSTRACT

The nutrition product may contain protein, at least one sweetener and/or a sugar, a dietary fiber, and a potassium compound. Advantageously, the nutrition product of the present disclosure may have an improved taste through the use of compounds that are not conventionally used as sweeteners, such as potassium compounds and the dietary fiber.

### CROSS REFERENCE TO RELATED APPLICATIONS

This application claims the benefit of U.S. Provisional Application Ser. No. 62/884,212, filed on Aug. 8, 2019. The entire disclosure of the above application is hereby incorporated herein by reference.

### FIELD

The present disclosure relates to nutrition products, and more particularly, to sweetening compositions for protein-based nutrition products.

### BACKGROUND

The statements in this section merely provide background information related to the present disclosure and may not constitute prior art.

Protein-based products are used for many purposes. These products may contain protein as the only nutrient supplied in substantial amounts relative to nutrient needs. Alternatively, protein can be combined with other nutrients such as vitamins and minerals in amounts that substantially contribute to needs. Generally, these products are sold as bars, ready-to-drink beverages, or as a powder to which the consumer adds water or another liquid. Some of such products contain substantial amounts of sugar, usually as sucrose. This gives a taste that appeals to many consumers.

However, some consumers don't want the calories or perceived negative health effects of these amounts of sugar. Also, with some medical conditions, high sugar intake at one time can directly cause problems. For example, people who have had bariatric surgery can contract a condition called dumping syndrome with even moderately high sugar consumption.

Therefore, many protein-based nutrition beverages do not have added sugar. These beverages don't necessarily taste the same as the high sugar products. In fact, these products often taste bitter and/or produce an undesirable aftertaste. Some consumers find the taste and aftertaste acceptable, or at least tolerable. On the other hand, many consumers would prefer a better taste.

Protein-based nutrition beverages are mostly sweetened either without added sugar, or with a substantial amount of sugar. A few protein products mix moderately low sugar amounts plus other sweeteners. In each of these cases, the tastes may not meet the wants of all consumers. Some commercially available protein beverages have already tried a moderately low sugar approach. For example, FitPro Go™, which is commercially available from FitPro USA, has eight (8) grams of sugars with some coming as lactose from added milk. The product also has monk fruit and Stevia. Some other products combine low amounts of sugar with artificial sugars.

There is a continuing need for a nutrition product that includes compounds that are not conventionally sweeteners but that provide an improved taste. Desirably, the nutrition compound will have a relatively low amount of added sugars.

### SUMMARY

In concordance with the instant disclosure, a nutrition product that includes compounds that are not conventionally sweeteners but that provide an improved taste, and which has a relatively low amount of added sugars, has been surprisingly discovered.

The present technology uses new ingredient compositions to produce good tasting protein beverages with either no added sugar or moderate amounts of sugar. The present technology embodiments all comprise or consist of no or moderately low amounts of added sugar (e.g., 0 g to 12 g per serving). The sugar would generally be sucrose, though it can be other sugars including sugar found in crude product ingredients (e.g., lactose sugar in milk). The embodiments with sugar combine sugar with other sweeteners within certain fixed ranges. As a non-limiting example, some embodiments may include Stevia. All embodiments may include potassium salts. In a specific, non-limiting example, the preferred form of potassium salt may be gluconate. Lastly, certain embodiments include addition of dietary fiber, most particularly a dextrin.

It has been surprisingly found that potassium as gluconate militates against bad aftertaste and may enhance good taste of certain sweeteners in protein-based beverages. These sweeteners could be used in place of, or in addition to sugar. Unlike the potassium naturally present in foods, the potassium fortifiers added to foods and beverages are known for tasting salty and slightly bitter. Therefore, adding these potassium forms may be expected to cause an unpalatable sensory perception in a sweet beverage. However, the addition of certain potassium salts to protein in combination with certain sweeteners surprisingly improved taste.

The sweetening formulations described herein can apply to protein-based beverages and nutrition bars. Although protein bars and beverages are sold primarily to provide protein, products can also contain other nutrients including, but not limited to, vitamins, minerals, other essential nutrients, non-essential nutrients, and herbs and their extracts. The sweetening formulations described herein can be applied to products containing various flavorings such as, but not limited to, vanilla, chocolate, and strawberry.

The present technology can pertain to sweetening of protein-based beverages. The amount of protein and volume per serving can vary. Protein-based beverages generally have protein per serving that ranges from 10 g to 42 g, though higher or lower amounts can show up. A serving for ready-to-drink commercial products is typically about 8 fluid ounces. However, higher volumes can be used. For example, a Premiere Protein® plastic bottle can be 14 ounces. Often, protein is sold as a powder for the consumer to mix with liquid. In that case, the serving size is whatever the consumer uses, though a volume is recommended on the package (typically 8 to 14 ounces).

Nutrition products accordingly to the present technology can be made as a protein bar or similar form, a powder to which a liquid such as water is added by the consumer, or as a ready-to-drink product containing water and/or other liquids including, but not limited to milk. For protein bars, a single serving would be in the range of 50 g to 80 g of total product. One serving of beverages, premade or after the consumer adds liquid, generally would be between 4 to 16 fluid ounces. Larger volumes per container are possible but should not be interpreted as a single serving. In addition, a product could be made that produces the compositions of the current technology where the consumer adds a preparation to unflavored and/or unsweetened protein products.

In one embodiment of the present disclosure, the nutrition product includes protein, which is present in an amount per serving of about 9 grams to about 60 grams; a potassium compound, which is present in an amount per serving that provides about 400 mg to about 1000 mg of elemental potassium per serving; water soluble dextrin, which is present in an amount per serving of about 2 grams to about 15 grams; acesulfame potassium, which is present in an amount per serving from about 5 mg to about 50 mg; and sucralose, which is present in an amount per serving from about 20 mg to about 300 mg. It should be appreciated that this embodiment may contain no sugar.

In an additional embodiment, the nutrition product includes protein, which is present in an amount per serving of about 9 grams to about 60 grams; a potassium compound, which is present in an amount per serving that provides about 400 mg to about 1000 mg of elemental potassium per serving; water soluble dextrin, which is present in an amount per serving of about 2 grams to about 15 grams; a sugar, which present in an amount per serving of less than about 12 grams; Stevia, present in an amount per serving with the sweetness equivalent of about 0.8 g to about 17 g of sucrose per serving; acesulfame potassium, which is present in an amount per serving from about 5 mg to about 50 mg; and sucralose, which is present in an amount per serving from about 20 mg to about 300 mg.

In a further embodiment, the nutrition product includes protein, which is present in an amount per serving of about 9 grams to about 60 grams; a potassium compound, which is present in an amount per serving that provides about 400 mg to about 1000 mg of elemental potassium per serving; water soluble dextrin, which is present in an amount per serving of about 2 grams to about 15 grams; a sugar, which present in an amount per serving of less than about 12 grams; Stevia, present in an amount per serving with the sweetness equivalent of about 0.8 g to about 17 g of sucrose per serving; and allulose, which is present in an amount per serving of from about 8 grams to about 16 grams. It should be appreciated that this embodiment contains only natural sugar as added sweeteners

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The present disclosure is directed to a nutrition product. Exemplary forms for the nutrition product, as described hereinbelow, include a protein powder, a ready-to-drink protein shake, a protein bar, a protein bite, and a protein gel. In particular the nutrition product may contain protein, a potassium compound, at least one sweetener, and a dietary fiber as described herein. It should be appreciated that the potassium compound is added to the nutrition product as an addition to, and therefore does not include, any potassium otherwise found in the protein. The at least one sweetener may be selected from the group consisting of acesulfame potassium, sucralose, sucrose, Stevia and combinations thereof.

The terminology used in the specification provided herein below is hereby defined to include similar and/or equivalent terms, and/or alternative embodiments that would be considered obvious to one skilled in the art given the teachings of the present patent application. Additionally, the words “a,” “an,” and “one” are defined to include one or more of the referenced items unless specifically stated otherwise. Also, the terms “have,” “include,” “contain,” and similar terms are defined to mean “comprising” unless specifically stated otherwise.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

Nutrition products and compositions are understood to further include any number of optional additional ingredients, including conventional food additives, for example one or more acidulants, additional thickeners, buffers or agents for pH adjustment, chelating agents, colorants, emulsifies, excipients, flavor agents, minerals, osmotic agents, pharmaceutically acceptable carriers, preservatives, stabilizers, and/or texturizers. The optional ingredients can be added in any suitable amount.

Compositions and products of the present disclosure may also include, for example, antioxidants, non-essential nutrients such as phytochemicals or certain omega-3 fatty acids, and essential nutrients such as vitamins and minerals. As used herein the term “antioxidant” is understood to include any one or more of various substances (as beta-carotene (a vitamin A precursor), vitamin C, vitamin E, and selenium) that inhibit oxidation or reactions promoted by Reactive Oxygen Species (ROS) and other radical and non-radical species. Additionally, antioxidants are molecules capable of slowing or preventing the oxidation of other molecules.

As used herein the term “vitamin” is understood to include any of various fat-soluble or water-soluble organic substances essential in minute amounts for normal growth and activity of the body and obtained naturally from plant and animal foods or synthetically made, pro-vitamins, derivatives, analogs. Non-limiting examples of vitamins include vitamin A, vitamin B1 (thiamine), vitamin B2 (riboflavin), vitamin B3 (niacin or niacinamide), vitamin B5 (pantothenic acid), vitamin B6 (pyridoxine, pyridoxal, or pyridoxamine, or pyridoxine hydrochloride), vitamin B7 (biotin), vitamin B9 (folic acid), and vitamin B12 (various cobalamins; commonly cyanocobalamin in vitamin supplements), vitamin C, vitamin D, vitamin E, vitamin K, folic acid and biotin.

The nutrition composition includes a purified or processed protein, such as soy protein, whey protein, rice protein, hemp seed protein, casein protein, and milk protein, as non-limiting examples. In particular embodiments, the protein is a whey protein.

The protein may be understood to include at least one an amino acid selected from the group consisting of isoleucine, alanine, leucine, arginine, lysine, aspartate, aspartic acid, methionine, cysteine, phenylalanine, threonine, tryptophan, glycine, valine, proline, histidine, serine, tyrosine, asparagine, selenocysteine, pyrrolysine, glutamate, glutamic acid, and glutamine.

In certain embodiments, the at least one sweetener may be Acesulfame potassium or Ace K. Ace K is a calorie-free sugar substitute or artificial sweetener. Ace K is commercially available under the trade names SUNETT® and SWEET ONE®. Acesulfame potassium is a potassium salt of 6-methyl-1,2,3-oxathiazine-4(3H)-one 2,2-dioxide.

Acesulfame potassium is 200 times sweeter than sucrose common sugar, as sweet as aspartame, about two-thirds as sweet as saccharin, and one-third as sweet as sucralose. Like saccharin, Ace K has a slightly bitter aftertaste, especially at high concentrations.

Acesulfame potassium has a smaller particle size than sucrose. Advantageously, the smaller particle size allows for mixtures containing Ace K to be more uniform than mixtures with sucrose. Unlike other artificial sweeteners, Acesulfame potassium is stable under heat and under moderately acidic or basic conditions. Advantageously, nutritional compositions containing Ace K are, therefore, more shelf stable compared to nutrition products with other sweeteners.

In certain embodiments, the Ace K may be present in an amount per serving from about 1 mg to about 75 mg, more particularly from about 5 mg to about 50 mg, and most particularly about 20 mg.

In other embodiments, the sweetener may be sucralose. Sucralose is an artificial sweetener and sugar substitute. Sucralose may be produced by a chlorination of sucrose. Sucralose is about 320 to 1,000 times sweeter than sucrose, three times as sweet as both aspartame and acesulfame potassium, and twice as sweet as sodium saccharin. Sucralose is commercially available under the trade name SPLENDA®. Sucralose has a chemical name of 1,6-Dichloro-1,6-dideoxy-β-D-fructofuranosyl-4-chloro-4-deoxy-α-D-galactopyranoside.

Although sucralose provides sweetness, a structure of sucralose militates against breakdown by enzymes in a digestive tract of a consumer. Most consumed sucralose (about 85 percent) is not absorbed in the digestive tract. Of an amount absorbed (about 15 percent) by the digestive tract, none is broken down for energy. Advantageously, the sucralose may not provide any calories to the nutrition product.

In certain embodiments, the sucralose may be present in an amount per serving from about 1 mg to about 500 mg, more particularly from about 20 mg to about 300 mg, and most particularly about 20 mg.

In further embodiments, the at least one sweetener may be Stevia. Stevia is a sweetener and sugar substitute derived from the leaves of the plant species Stevia rebaudiana. Stevia may have a plurality of active compounds including steviol glycosides. The steviol glycosides may include stevioside and rebaudioside, which have 30 to 150 times the sweetness of sugar. Stevia may be heat-stable, pH-stable, and not fermentable. The digestive tract does not metabolize the glycosides in Stevia. Stevia's taste has a slower onset and longer duration than that of sugar, and some of its extracts may have a bitter or licorice-like aftertaste at high concentrations.

In certain embodiments, the Stevia may be present in an amount per serving that provides an equivalent sweetness of about 0.8 g to about 17 g of sucrose.

In additional embodiments, the nutrition product may contain a sugar. The sugar may be sucrose. Sucrose is common sugar. Sucrose is a disaccharide, which is a molecule composed of two monosaccharides: glucose and fructose. Sucrose is produced naturally in plants, from which table sugar is refined. Sucrose has the molecular formula C₁₂H₂₂O₁₁. However, it should be appreciated that the nutrition product of the present disclosure may contain only minimal amounts of added sucrose.

In particular, the sucrose may be present in an amount per serving from about 0 grams to about 12 grams. More particularly, the sucrose may be present in an amount of about 8 grams per serving.

The sugar of the nutrition product may include allulose. Allulose is a low-calorie monosaccharide sugar. Allulose has a sweetness that is estimated to be 70% of the sweetness of sucrose.

In certain embodiments, the allulose may be present in an amount per serving from about 8 g to about 16 g.

It should be appreciated that where sucrose is utilized in the nutrition product another sugar may be used in an amount that provides a sweetness equivalent to the amount of sucrose. Likewise, it should be understood that sucrose and another sugar may be used in combination in an amount that provides the sweetness equivalent to the sucrose alone. Other suitable sugars may be one of honey, corn syrup, and a sugar alcohol, as non-limiting examples.

The potassium compound may be one of potassium gluconate, potassium lactate, and a combination thereof. While bound to no particular theory, it has been found that potassium gluconate and potassium lactate can improve the taste of protein based nutrition products. This result is unexpected as potassium fortifiers are known in the art for having a relatively bitter or briny taste. Additionally, it has been found that a combination of the potassium compound and the sweetener may has been found to enhance the overall taste of the nutrition product. It should be appreciated that the sodium counterpart for each of potassium gluconate and potassium lactate may be substituted either wholly or in part into the nutrition product of the present disclosure, as desired.

Potassium gluconate is a potassium salt of a conjugate base of gluconic acid. It is also referred to as 2,3,4,5,6-pentahydroxycaproic acid potassium salt, D-gluconic acid potassium salt, or potassium D-gluconate. Potassium gluconate is a free flowing, white to slightly yellow, crystalline powder with a slightly bitter taste. Potassium gluconate is commercially available in tablet and powdered form from a variety of retailers.

Potassium lactate is a compound with formula KC₃H₅O₃, or H₃C—CHOH—COOK. It is a potassium salt of lactic acid. It is produced by neutralizing lactic acid, which is fermented from a sugar source. Advantageously, it has a broad antimicrobial action and is effective at militating against spoilage and pathogenic bacteria where incorporated into nutrition products. Potassium lactate is commercially available as a liquid product that is usually 60% solids but is available at up to 78% solids.

It should be appreciated that the potassium compound may provide elemental potassium to the nutrition products. It should be understood that where particular amounts of potassium are discussed herein, the amount relates to the amount of elemental potassium provided by the potassium compound. Additionally, the amounts of elemental potassium provided by the potassium compound should be understood as being in addition to any potassium that may be present in the other ingredients of the nutrition product. In certain embodiments, elemental potassium provided by the potassium compound may be present in an amount per serving from about 400 mg to about 1000 mg, more particularly from about 500 mg to about 800 mg, and most particularly about 675 mg.

The nutrition product may optionally contain a dietary fiber. While bound to no particular theory, it is believed that a combination of the dietary fiber, the sweetener, and the potassium compound may improve the taste of the nutrition product. The combination may likewise militate against bitterness or any negative aftertaste in the nutrition product. Additionally, the dietary fiber may produce a creamy texture of the nutrition product, which is desirable for ready-to-drink applications. Water soluble dextrin has been found particularly beneficial and well suited for the nutrition product. For example, and in a most particular embodiment, water soluble dextrin fiber may be NUTRIOSE®, which is commercially available from Roquette America, Inc. of Geneva, Ill.

It should be understood that certain types of dietary fiber have been found unsuitable for the nutrition product of the present disclosure and are not to be employed. For example, the dietary fiber of the present disclosure cannot contain inulin, which is a group of naturally occurring polysaccharides produced by many types of plants. Inulin has been found to provide an unacceptable taste relative to water soluble dextrin fiber when used in the nutrition product as described herein.

In certain embodiments, the dietary fiber may be present in an amount per serving from about 2 g to about 15 g, more particularly from about 5 g to about 8 g.

In a first exemplary embodiment, the nutrition product may include about 9 grams to about 60 grams of protein per serving. The protein may be sweetened with Stevia to a sweetness equivalent of about 0.8 g to about 17 g of sucrose per serving. Additionally, the nutrition composition may include about 5 mg to about 50 mg of Ace K per serving or about 20 mg to about 300 mg sucralose per serving. The composition may also include about 2 g to about 12 g of sucrose, however, this sucrose may be partially or fully substituted with another natural sugar to an equivalent sweetness. The other natural sugar may be one of allulose, honey, corn syrup, and sugar alcohols such as erythritol. The potassium compound may be present in an amount that provides an amount of elemental potassium of about 400 mg to about 1000 mg per serving, where the potassium compound is in addition to potassium that may be present in the other components of the nutrition product, as described hereinabove. Additionally, the nutrition product may contain water soluble dextrin.

In a second exemplary embodiment, the nutrition product has about 15 grams to about 45 grams of protein per serving. The protein may be sweetened with about 7 grams sucrose per serving; however, this sucrose may be partially or fully substituted with another natural sugar to an equivalent sweetness. The natural sugar may be one of allulose, honey, corn syrup, and sugar alcohols such as erythritol. The nutrition product may include Stevia in an amount with a sweetness equivalent to about 8 g sucrose per serving. The nutrition product may also include about 12 mg per serving of Ace K, and about 60 mg per serving of sucralose. The nutrition composition may have about 500 mg to about 700 mg of elemental potassium provided by one of potassium gluconate, potassium lactate, or combinations thereof. Additionally, the nutrition product may contain from about 4 g to about 8 g of water soluble dextrin.

In a third exemplary embodiment, the nutrition product may include about 9 grams to about 60 grams of protein per serving. The protein may be sweetened with about 5 mg to about 50 mg of Ace K per serving and/or about 20 mg to about 300 mg of sucralose per serving. The elemental potassium may be present in an amount of about 400 mg to about 1000 mg per serving, where the potassium compound is in addition to potassium that may be present in the other components of the nutrition product, as described hereinabove. Additionally, the nutrition product may contain water soluble dextrin.

In a fourth exemplary embodiment, the nutrition product has about 15 grams to about 45 grams of protein per serving. The protein may be sweetened with about 20 mg of Ace K per serving and about 100 mg per serving of sucralose. The nutrition composition may have about 500 mg to about 800 mg of elemental potassium provided by of the potassium compound. Additionally, the nutrition product may contain about 7 g of water soluble dextrin.

In a fifth exemplary embodiment, the nutrition product has about 15 grams to about 45 grams of protein per serving. The protein may be sweetened with about 8 g of sucrose; however, this sucrose may be partially or fully substituted with another natural sugar to an equivalent sweetness. The natural sugar may be one of honey, corn syrup, and sugar alcohols such as erythritol. The nutrition product may also include Stevia in an amount with an equivalent sweetness of about 8 g sucrose per serving, and about 12 g of allulose per serving. The nutrition composition may have about 500 mg to about 700 mg of elemental potassium provided by the potassium compound. Additionally, the nutrition product may contain from about 5 g to about 8 g of water soluble dextrin.

As may be presented herein, the language “consisting essentially of” is meant to limit the scope of the claim to the specified materials that do not materially affect the basic and novel characteristics of the nutrition product. Thus, the nutrition product consisting essentially of protein, at least one sweetener, the dietary fiber such as water soluble dextrin fiber, and the potassium compound, excludes ingredients which may materially affect the basic and novel characteristics of the nutraceutical formulation.

In particular applications, ingredients which materially affect the basic and novel characteristics of the nutrition product may include ingredients that affect the taste of the product. More particularly, ingredients that have a bitter or salty after taste are omitted from the nutrition product as the nutrition product is configured to be more palatable compared to conventional nutrition products.

Additionally, as may be presented in the claims below, the language “consisting of” is intended to exclude any ingredient not specified in the claim. Accordingly, the nutrition product consisting essentially of protein, at least one sweetener, the dietary fiber such as water soluble dextrin, and the potassium compound includes only those ingredients.

The benefits of the nutrition product of the present disclosure may be tested as described hereinbelow.

In one testing example, the nutrition product may include 15 grams to about 45 grams of protein per serving, 8 g of sucrose per serving, Stevia in an amount with an equivalent sweetness of about 8 g sucrose per serving, about 12 g of allulose per serving, about 500 mg to about 700 mg of elemental potassium provided by the potassium compound, and about 5 g to about 8 g of water soluble dextrin.

A serving of the nutrition product and a serving of a conventional nutrition product without the potassium compound will be served to a consumer. For example, each of the nutrition products may be a protein powder, which may be used to create a protein shake with an addition of eight (8) ounces of water.

The consumer will not be aware which serving contains the potassium compound. The consumer will taste the protein shake created from each of the nutrition product of the present disclosure, and the consumer will provide an opinion on a taste of the protein shake. After approximately five (5) minutes, the consumer will provide an opinion on the aftertaste of the nutrition product. More particularly, the opinion of the consumer will relate to an overall taste of the product, a texture or consistency of the product, and a presence of a foul aftertaste.

The same procedure will be repeated for the protein shake created from the conventional nutrition product, without the potassium compound. The consumer will provide an opinion on the taste and the aftertaste of the potassium compound compared to the nutrition product of the present disclosure.

It is expected that the consumer will find that the nutrition product of the present disclosure is overall better tasting, has a more pleasant texture or consistency, and has a better aftertaste where compared to a conventional nutrition product.

Advantageously, the nutrition product of the present disclosure may include compounds that are not conventionally used in the art, such as potassium compounds and water soluble dextrin fiber, which have been shown to improve the overall taste and militate against an adverse aftertaste of the nutrition product.

The use of a potassium compound to enhance taste properties of a sweet beverage originated from an unexpected discovery. The present technology has found that over 400 mg of potassium as gluconate could militate against a bad aftertaste and enhance good taste of certain sweeteners in protein-based beverages. These sweeteners could be used in place of or in addition to sugar. This effect of the amount of potassium, provided in certain embodiments as potassium gluconate, was surprising. Unlike the potassium naturally present in foods, the potassium fortifiers added to foods and beverages are known for tasting salty and slightly bitter. Therefore, adding these potassium forms would be expected to cause an unpalatable sensory perception in a sweet beverage. Thus, the addition would certainly not be expected to enhance the desirable taste of sweeteners.

In fact, the amount of potassium gluconate described hereinbelow would not be found in nature and would not be used in beverages for taste and other reasons. These contentions are supported by the following statements within the industry:

“ . . . Foremost, potassium tastes terrible,” said Brandon Armstrong, a food scientist in the nutritional ingredients division of Watson, Inc., West Haven, Conn. “On top of that, 100% D.V. is 3.5 grams, which for many products is a significant per cent of the finished product weight, and that doesn't account for activity level. It would take more than 7 grams of raw material per serving to have 100% Daily Value of potassium in a product, he said . . . “At best, the resulting product would taste like sea water,” Mr. Armstrong said. “So, using more than 10% D.V. in a formulation is usually a bad idea, and even at that level, the flavor has to be mitigated to a degree,” (available online at www.bakingbusiness.com/articles/27781 -potassium-promising-yet-problematic, last accessed Aug. 8, 2020).

“Minerals such as sodium, potassium, magnesium, calcium, phosphorous and chloride are inherently present in the whey protein isolate, the carbohydrate, the water, the vitamins, trace and ultra-trace minerals used to produce the product. For example, an inherent concentration level for potassium can be in the range of from about 10-30 mg/100 ml, most particularly no more than 20 mg/100 ml. Although it may be considered of higher nutritional value to have the nutritional beverage contain the foregoing minerals or macro-nutrients, the presence of these minerals reduces the clarity and textural properties of the inventive beverage.” See U.S. Pat. No. 5,641,531 to Liebrecht at column 3, lines 21-42.

While certain representative embodiments and details have been shown for purposes of illustrating the invention, it will be apparent to those skilled in the art that various changes may be made without departing from the scope of the disclosure, which is further described in the following appended claims.

What is claimed is:

1. A nutrition product, comprising:
protein, present in an amount per serving of about 9 grams to about 60 grams;
a potassium compound, the potassium compound present in an amount per serving that provides about 400 mg to about 1000 mg of elemental potassium per serving;
water soluble dextrin, the water-soluble dextrin present in an amount per serving of about 2 grams to about 15 grams;
acesulfame potassium, present in an amount per serving from about 5 mg to about 50 mg; and
sucralose, present in an amount per serving from about 20 mg to about 300 mg.

2. The nutrition product of claim 1, wherein the potassium compound includes a member selected from a group consisting of potassium gluconate, potassium lactate, and a combination thereof.

3. The nutrition product of claim 1, wherein the product is one of a protein powder, a ready-to-drink protein shake, a protein bar, a protein bite, and a protein gel.

4. The nutrition product of claim 1, wherein the product includes no added sugar.

5. A nutrition product, comprising:
protein, present in an amount per serving of about 9 grams to about 60 grams;
a potassium compound, the potassium compound present in an amount per serving that provides about 400 mg to about 1000 mg of elemental potassium per serving
water soluble dextrin, the water-soluble dextrin is present in an amount per serving of about 2 grams to about 15 grams;
a sugar, present in an amount per serving of less than about 12 grams;
Stevia, present in an amount per serving with the sweetness equivalent of about 0.8 g to about 17 g of sucrose per serving;
acesulfame potassium present in an amount per serving from about 5 mg to about 50 mg; and
sucralose, present in an amount per serving from about 20 mg to about 300 mg.

6. The nutrition product of claim 5, wherein the potassium compound includes a member selected from a group consisting of potassium gluconate, potassium lactate, and a combination thereof.

7. The nutrition product of claim 5, wherein the product is one of a protein powder, a ready-to-drink protein shake, a protein bar, a protein bite, and a protein gel.

8. The nutrition product of claim 5, wherein the sugar includes a member selected from a group consisting of sucrose, allulose, honey, corn syrup, a sugar alcohol, and combinations thereof.

9. A nutrition product, comprising:
protein, present in an amount per serving of about 9 grams to about 60 grams;
a potassium compound, the potassium compound present in an amount per serving that provides about 400 mg to about 1000 mg of elemental potassium per serving;
water soluble dextrin, the water-soluble dextrin is present in an amount per serving of about 2 grams to about 15 grams;
a sugar, present in an amount per serving of less than about 12 grams per serving;
Stevia, present in an amount per serving with the sweetness equivalent of about 0.8 g to about 17 g of sucrose per serving; and
allulose, present in an amount per serving of from about 8 grams to about 16 grams.

10. The nutrition product of claim 9, wherein the potassium compound includes a member selected from a group consisting of potassium gluconate, potassium lactate, and a combination thereof.

11. The nutrition product of claim 9, wherein the sugar is present in an amount of less than 8 grams per serving.

12. The nutrition product of claim 9, wherein the product is one of a protein powder, a ready-to-drink protein shake, a protein bar, a protein bite, and a protein gel.

13. The nutrition product of claim 9, wherein the sugar includes a member selected from a group consisting of sucrose, honey, corn syrup, a sugar alcohol, and combinations thereof.
